(19) United States
(12) Patent Application Publication
(10) Pub. No.: US 2008/0004884 A1
(43) Pub. Date: Jan. 3, 2008

(54) EMPLOYMENT OF OFFLINE BEHAVIOR TO DISPLAY ONLINE CONTENT

(75) Inventors: Gary W. Flake, Bellevue, WA (US); William H. Gates, Medina, WA (US); Eric J. Horvitz, Kirkland, WA (US); Joshua T. Goodman, Redmond, WA (US); Bradly A. Brunell, Medina, WA (US); Susan T. Dumais, Kirkland, WA (US); Alexander G. Gounares, Kirkland, WA (US); Trenholme J. Griffin, Bainbridge Island, WA (US); Xuedong D. Huang, Bellevue, WA (US); Oliver Hurst-Hiller, New York, NY (US); Kenneth A. Moss, Mercer Island, WA (US); Kyle G. Peltonen, Issaquah, WA (US); John C. Platt, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/427,680

(22) Filed: Jun. 29, 2006

(51) Int. Cl. G06Q 30/00

(52) U.S. Cl. 705/1

(57) ABSTRACT

Architecture for targeted advertising using offline user behavior information. Information relating to offline behavior can be collected from cell phones, geolocation systems, credit card information, restaurants, grocery stores, etc., and this information is aggregated and employed in connection with selecting and displaying targeted advertising to a user when online. Machine learning and reasoning can be employed to make inferences and dynamically tune advertisement processing. Offline user information can also be employed to enhance context-based searching when the user goes online. The ranking of search results and content for display can be modified as a function of offline behavior. A system is provided that facilitates online advertising based on at least offline activity using a profile component for aggregating offline behavior information of a user and generating a related user profile. An advertising component employs the user profile in connection with delivery of an advertisement to the user when online.

### CROSS REFERENCE TO RELATED APPLICATIONS

This application is related to co-pending U.S. patent application Ser. No. ______ (Atty. Dkt. No. MSFTP1414US) entitled “USING OFFLINE ACTIVITY TO ENHANCE ONLINE SEARCHING” (Flake, et al.) filed of even date, the entirety of which is incorporated herein by reference.

### BACKGROUND

The Internet provides unprecedented opportunity for advertising to an ever-increasing number of potential customers ranging from businesses to individuals. Money expended for online advertising in the United States alone, is in the billions of dollars per year, and continues to increase with no end in sight. Accordingly, merchants (as well as non-merchants) are employing online advertising as a means of attracting an ever-increasing number of potential customers ranging from businesses to individuals.

Businesses have long recognized that customer profile information can be invaluable with respect to sales and advertising. As a result, in many cases of real-world, offline (or brick-and-mortar) shopping, the merchant will at some time attempt to obtain customer information such as from a personal check or survey, by giving out free food samples along with the completion of a survey or customer feedback, and so on. Thereafter, flyers or brochures can be mailed to the user with some minimal level of personalization in order to portray a relationship between the merchant and the customer, the merchant hoping to entice the customer back for future purchases.

Various mechanisms are available for obtaining information about online user activity. For example, Internet websites routinely utilize cookies as a means of tracking user activity thereby providing information about the buying habits, goals, intentions, and needs large numbers of users. Additionally, loggers can log most user interactivity with the site, or many different sites, and report that information back to another site for its own purposes (e.g. for sale to yet another entity). Other systems with which potential customers routinely interact include cellular telephones and the associated cellular networks. Additionally, digital television systems are now providing added capability for viewers to interact with the presentation of products and/or services. Given the capability of now being able to route advertising on a one-on-one basis to millions of IP network users, businesses continue to seek additional sources of information to enhance targeted advertising to potential customers.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

Users spend a significant amount of time offline and by monitoring such offline activity, an in-depth profile of the user can be obtained which can improve selection and delivery of advertisements.

The disclosed architecture facilitates targeted advertising by employing offline user behavior information. Information relating to offline behavior is collected from cell phones, geolocation systems, credit card information, restaurants, grocery stores, etc., and this information is aggregated and employed in connection with selecting and displaying targeted advertising to a user when online so as to increase click-through rate by providing relevant advertisements to the user.

Machine learning techniques can be employed to correlate offline activity to online click-through rate so as to dynamically tune an advertisement component to display ads with high probability of click-through.

In one application, offline monitoring can also be employed to enhance context-based searching when the user goes online. For example, if the offline behavior indicates the user was watching a college football game, and thereafter, the user was watching television highlights of the game, if the user goes online during or just after such activity, then an inference could be made that the user is interested in seeing more information about the game as well as being receptive to advertisements selling college team memorabilia.

Likewise, a system can be employed to log the locations, and the associated businesses, resources, or other attributes, associated with places where a user has stopped and dwelled, via sensing and storing of one or more of GPS signals, Wi-fi radio signals, cell-tower radio signals, or other location-sensing modalities. Such logs can be employed to tailor search and advertising during online experiences so as to better interpret queries to search engines, to better target advertisements, and so on.

Accordingly, disclosed and claimed herein, in one aspect thereof, is a computer-implemented system that facilitates online advertising based on at least offline activity. A profile component aggregates offline behavior information of a user and generates a related user profile. An advertising component employs the user profile in connection with delivery of an advertisement to the user when the user is online.

In another implementation, the processing of searches and ranking of search results and other content to be displayed can be performed as a function of offline behavior. In support thereof, a computer-implemented system is provided that facilitates online searching. A profile component aggregates offline behavior information of a user and generates a related user profile. A search component employs the user profile in connection with generating and processing of a user search when the user is online. In yet another implementation, offline behavior ranking can also be used to facilitate creation of personalized online yellow pages.

In yet another aspect thereof, machine learning and reasoning is provided to prognose or infer an action related at least to advertising and searching that a user desires to be automatically performed.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that facilitates online advertising.

FIG. 2 illustrates a methodology of advertising online in accordance with an innovative aspect.

FIG. 3 illustrates a block diagram of an alternative system for online advertising based on offline user behavior.

FIG. 4 illustrates a block diagram of an implementation of an alternative system that facilitates advertising based on offline user behavior.

FIG. 5 illustrates a flow diagram of a methodology of correlating online click-through rate with offline activity.

FIG. 6 illustrates a flow diagram of a methodology of storing and presenting advertisements on a client system based on offline user activity.

FIG. 7 illustrates a methodology of modeling what a user knows or does not know based on offline user activity and using this model for online targeted advertising.

FIG. 8 illustrates a system that facilitates brokering of offline user activity information in accordance with an innovative aspect.

FIG. 9 illustrates a flow diagram of a methodology of brokering user offline information.

FIG. 10 illustrates a methodology of advertising as represented by a viral ecosystem model for advertising.

FIG. 11 illustrates a block diagram of a system that employs offline user information in support of searching and search processes.

FIG. 12 illustrates a methodology of using offline user activity data in support of online searching in accordance with an innovative aspect.

FIG. 13 illustrates a methodology of using offline user activity data in support of search ranking in accordance with an aspect.

FIG. 14 illustrates a methodology of using offline user activity data in support of creating personal online yellow pages in accordance with an aspect.

FIG. 15 illustrates a methodology of using offline user activity data for context-based searching in accordance with an aspect.

FIG. 16 illustrates a block diagram of a computer operable to execute the disclosed offline profile advertising and searching architecture.

FIG. 17 illustrates a schematic block diagram of an exemplary computing environment for offline profile advertising and searching in accordance with another aspect.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Users spend a significant amount of time offline and by monitoring such offline activity, an in-depth profile of the user can be obtained and utilized to improve selection and delivery of advertisements related to the user's topics of interest, as well as for searching.

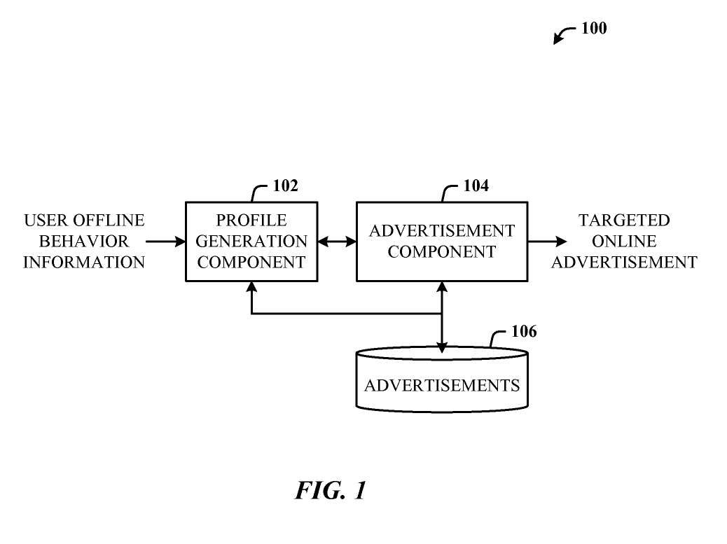

Referring initially to the drawings, FIG. 1 illustrates a computer-implemented system 100 that facilitates online advertising. The system 100 includes a profile generation component 102 that receives user activity data related to offline activity of the user, and stores the offline activity data in a user profile. The offline activity can be associated with and obtained (manually and/or automatically) from the use of a cell phone, credit card information, banking information, and purchase transactions related to restaurants and grocery stores, to name just a few sources of offline activity information. This information is aggregated and employed in connection with selecting and presenting (e.g., displaying) targeted advertising to a user when online so as to increase click-through rate, for example, by providing advertisements relevant to the user's topics of interest. Click-through rate is a way of measuring the success (or failure) of online advertising. In one computation of click-through rate, the rate value is computed by dividing the number of users who clicked on the webpage advertisement by the number of times the advertisement was delivered. Other metrics for can be employed to measure the quality of the advertisements selected and presented, such as CPM (or cost per thousand impressions), which is described infra.

It is also within contemplation of the disclosed architecture that online behavior can be processed and utilized to affect offline behavior. For example, information about user interactivity with online information such as a movie or television program website can be used to affect what programs and/or advertising to prioritize for presentation to the user when the user watches television. More specifically, if it is known that many users from a geographic area (via website registration data) access and click-through certain website ads, this information can be employed to then present one type of ad over another via television to users in that same geographic area.

In another example, based on online information (e.g., user interaction with a sports website), the online information can be retrieved and processed to affect certain types of coupons (e.g., related to sports drinks or beer) to be output to the user at the point-of-sale of a brick-and-mortar (B&M) establishment. This can be initiated by the user scanning a credit card (e.g., debit card, vendor loyalty card, discount card, or any input mechanism that provides association with who is making the purchase) into the B&M system, which is then used to match and receive online-stored user interaction and/or subscriber, or user preferences information for further analysis and processing to generate the desired offline actions.

In still another example, online user interaction data can include the accessing of travel websites and the purchase of airline tickets to a foreign country (e.g., Italy). This information can then be employed to provide printed coupons at B&M establishments for travel related items the user (or spouse) will visit before departure to the foreign country. Rather than providing coupons at B&M establishments, offline behavior can include mailing to the user address brochures and other related travel information, for example. These are only a few examples, and are not to be construed as limiting in any way.

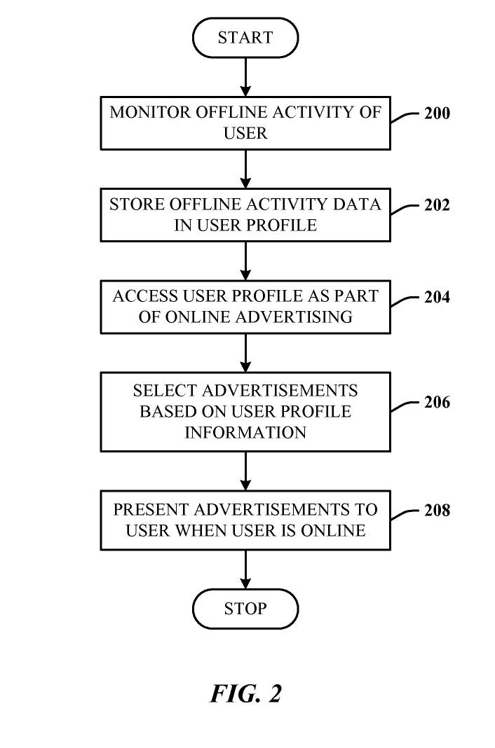

FIG. 2 illustrates a methodology of advertising online in accordance with an innovative aspect. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, offline user activity is monitored and tracked for storage as offline activity data. At 202, the offline activity data is stored in a user profile. Storage of the user profile can be in an online entity for access to other network entities. At 204, the user profile is accessed as part of preparing and processing online advertising. At 206, a database of advertisements is accessed, and one or more advertisements are selected based on the user profile. At 208, the one or more advertisements are retrieved and presented to the user.

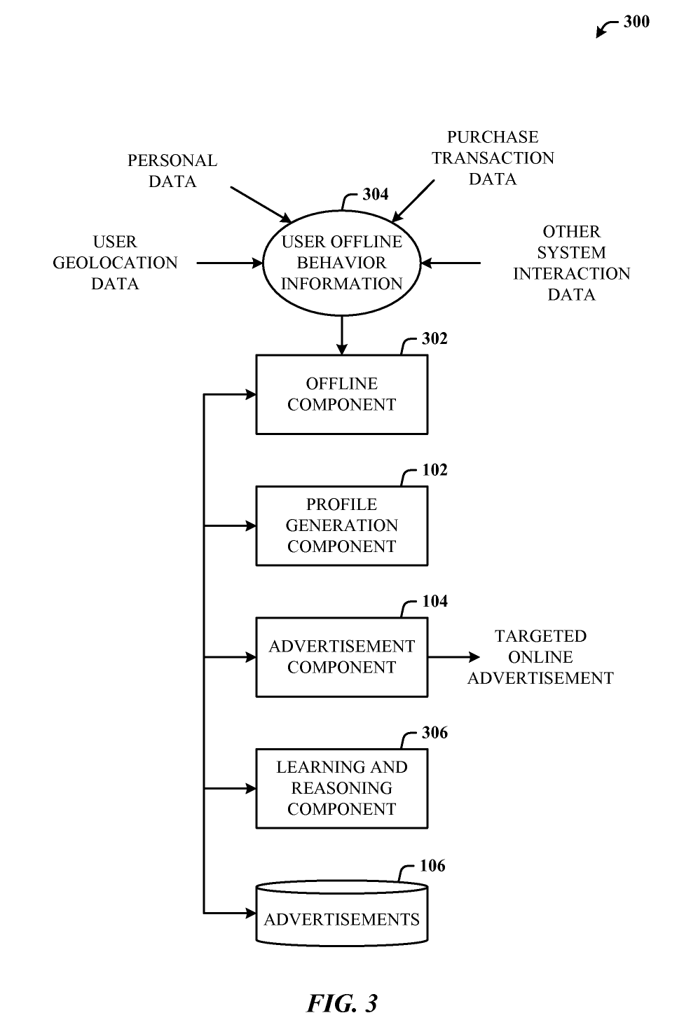

Referring now to FIG. 3, there is illustrated a block diagram of an alternative system 300 for online advertising based on offline user behavior. The system 300 includes the profile generation component 102, the advertisement component 104, and advertisements storage system 106, as described in FIG. 1. Additionally, the system 300 includes an offline component 302 that interfaces to external systems to receive offline user behavior information 304. Inputs to the behavior information 304 include at least user geolocation data (which can be obtained automatically via geographic location technologies, e.g. global positioning system), personal data (which includes personal financial data, person medical data, personal family data, and other data considered private), purchase transaction data (related to purchases made via retail brick-and-mortar establishments, as well as online purchases), and system interaction data (e.g., television content viewing, cell phones, computers, . . . ) associated with other systems that can be operated offline. The behavior information 304 is received by the offline component 302 and accessed for generating a user profile of offline information by the generation component 102.

Machine learning and reasoning techniques can also be employed to correlate offline activity to the online click-through rate so as to dynamically tune the advertisement component 104 to display ads with a high probability of successful click-through.

The system 300 employs a machine learning and reasoning (MLR) component 306 which facilitates automating one or more features in accordance with the subject innovation. The subject invention (e.g., in connection with selection) can employ various MLR-based schemes for carrying out various aspects thereof. For example, a process for determining which advertisement to select based on the user profile can be facilitated via an automatic classifier system and process. Moreover, where the datastore 106 of advertisements is distributed over several locations, the classifier can be employed to determine which datastore location will be selected for advertisements.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or other statistical analysis (e.g., one factoring into the analysis utilities and costs to maximize the expected value to one or more people) to prognose or infer an action that a user desires to be automatically performed.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also is inclusive of statistical regression that is utilized to develop models of ranking or priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions according to predetermined criteria.

In one alternative implementation, the MLR component 306 may be used to predict the probability of click-through on an advertisement, given a combination of online and offline information of a user. This probability can be produced by a classifier, whose inputs are one or more elements of a user's profile. The user profile offline information, as indicated above, can include offline activity associated with and obtained (manually and/or automatically) from the use of a cell phone, credit card information, banking information, and purchase transactions related to restaurants and grocery stores, to name just a few sources of offline activity information.

Cell phone activity can include user activity associated with messaging, types of information downloaded, types of subscribed cellular services, usage information, geolocation information of the device when the user interacts with the device, types of calls made (e.g., emergency), the frequency of calls made, ring tones, music downloaded, and so on.

Credit card information can include the types of purchases (e.g. clothing, groceries, restaurants, . . . ), frequency of purchases, payment history, etc. It is common for a credit card company to track and categorize transactions of an account, and issue this to the credit card user at year end. Some or all of this transaction information can be obtained, analyzed and processed for the selection and presentation of online advertisements and/or content.

Similarly, banking information can be analyzed for the types of purchases, frequency of transactions, spending habits, vendors frequented, spending dynamics at least with respect to when most transactions occur and with what vendor, payment history, and so on.

In general, obtaining user information related to purchase transactions can provide a wealth of information for analysis and from which to base selection and presentation of online advertising and/or content.

The number of advertisements can be large, so predictions for individual ads could become inaccurate. In this scenario, the ads can be grouped into clusters of related ads, through some mechanism (e.g., business type of the ad (travel, medicine, credit offer, etc.)). The classifier can then be used to predict the probability of clicking through on a type of ad.

It should be understood that there is a training phase of collecting data for such a classifier. Training data can be collected without changing the ad-serving logic. When the classifier is fielded, it could start to change the ads served to a user, which would then skew further training data that would be collected. One way to mitigate this is to only implement the system for 90%, for example, of the ads, and collect unbiased training data for the other 10%. Other suitable techniques can also be employed.

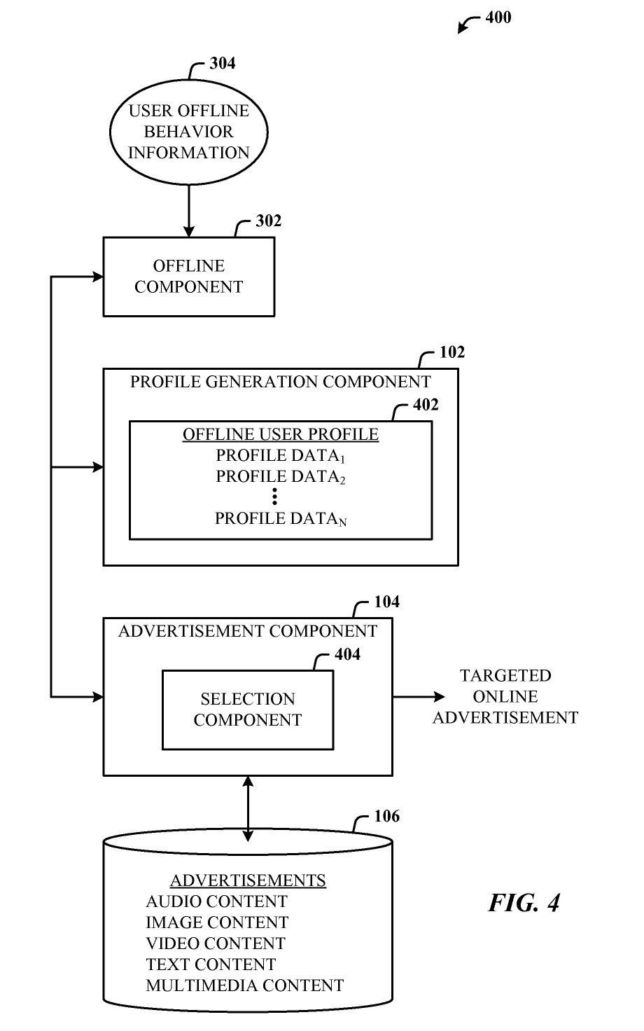

FIG. 4 illustrates a block diagram of an implementation of an alternative system 400 that facilitates advertising based on offline user behavior. The system 400 includes the offline component 302 that receives and stores offline behavior information 304 associated with a user. The profile generation component 102 generates and stores a user profile 402 of offline activities. It is to be appreciated that the user profile 402 need not be inclusive of all offline behavior information, but can be a subset thereof. The user profile 402 can be generated based on select pieces of offline user behavior information. For example, one user profile can include only activity that deals with cell phone activity. Another offline user profile can be created based only on user television activity, and so on. In any case, the user profile 402 can include many different pieces of profile data (denoted PROFILE DATA₁, PROFILE DATA₁, . . . , PROFILE DATA_{N}, where N is an integer).

The system 400 also includes the advertisement component 104 for selecting and processing advertisements of different content and in a variety of different formats. Here, the component 104 illustrates an included selection component 404 for selecting one or more advertisements stored in the advertisements datastore 106. In other words, the selected advertisement can be one having a format that includes only audio content, only image content, only video content, only textual content, or any combination of the above, listed as multimedia content. Selection of the format of the content can be based on the offline behavior information 304. For example, if the user offline behavior indicates that s/he enjoys predominantly audio-only content, this can be determined, and can affect selection of an advertisement for presentation as audio content.

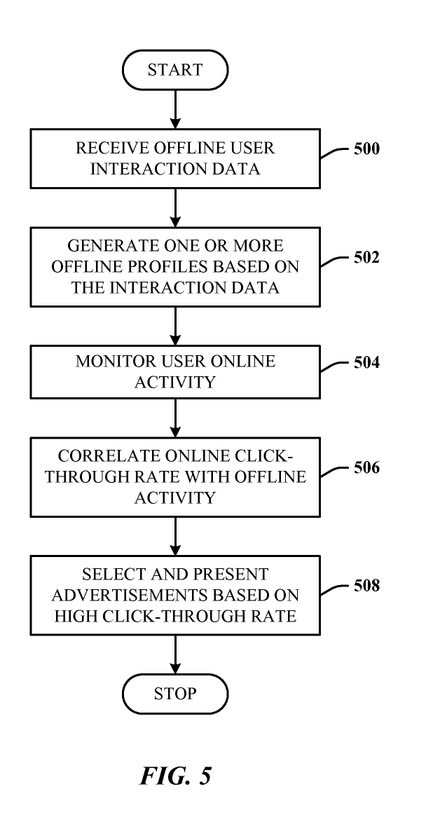

FIG. 5 illustrates a flow diagram of a methodology of correlating online click-through rate with offline activity. At 500, offline user data is received. At 502, one or more offline profiles are generated that include offline user interactivity information from any variety of sources. As indicated previously, more than one profile can be generated. Rather than develop one large offline profile, multiple offline profiles can be created for many different aspects of offline user activity. For example, one profile can be developed for personal account information utilized for purchase transactions, another profile for entertainment activity, and so on. When processing for millions of users, the more focused profile information can facilitate faster and more efficient processing in realtime advertising regimes. Moreover, statistical analysis related to clustering, for example, can be performed more quickly and efficiently, rather than having to extract portions of information from a single large profile source.

At 504, user online activity is monitored and an online user profile generated. Again, this can be a profile separate from a single offline profile or multiples offline profiles, or one large online and offline profile. At 506, correlation processing is performed between online click-through rate and offline activity. At 508, one or more advertisements are selected and presented to the user based on a high click-through rate. Similarly, if the click-through rate is below a predetermined parameter, advertisement selection can be revised based on other information.

It is within contemplation that the disclosed architecture can facilitate faster ad presentation to the user by storing the ad on the client system for quick retrieval. For example, if it is determined from offline information (e.g., geolocation information) that the user routinely visits art shows, bundled advertising can be downloaded to the user machine and selected advertisements extracted and presented. This can occur over a period of time until all downloaded ads have been determined to have outlived their usefulness (or aged out), and after which they are deleted from the user system.

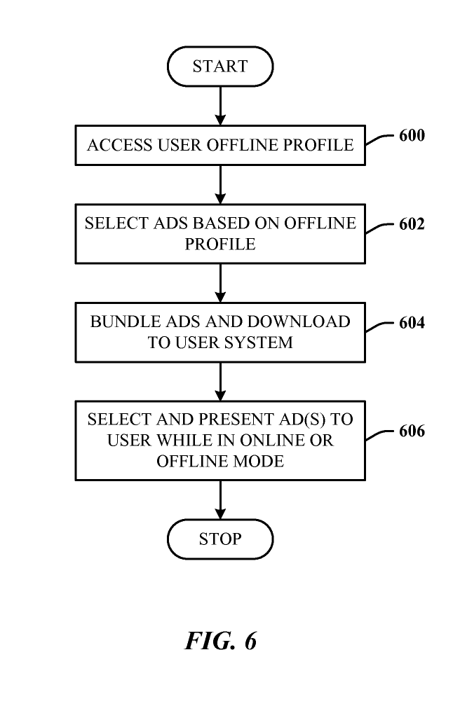

FIG. 6 illustrates a flow diagram of a methodology of storing and presenting advertisements on a client system based on offline user activity. At 600, offline profile information of a user is accessed. At 602, based on the offline user activity information, multiple advertisements are selected. At 604, the advertisements are bundled and downloaded to the user computing system. At 606, one or more of the advertisements are selected and presented to the user. Note this presentation process can include presenting the ads as part of an online or offline process. For example, the ad can be inserted into a suitable programmable language application and presented to the user while the user programming in an offline mode.

Another source of offline information can be the reaction of the user to information. For example, cameras, microphones, and/or systems that sense biometric information can be provided to monitor user demeanor to perception of certain information by the user such as facial demeanor information associated with a scowl, smile, and vocal data related to a laugh, moan, and so on. This offline data can be recorded, processed, and fed back for analysis to affect the type of advertising presented to the user when s/he goes online.

In a more robust implementation, the valuation of the ad can be based on the user demeanor or reaction to the ad. In the context of watching television programming, sensing systems can be employed to capture user reaction to ads and programming. This reaction information as well as the direct user interaction data associated with channel surfing, for example, can be utilized to formulate online advertising for targeting the user.

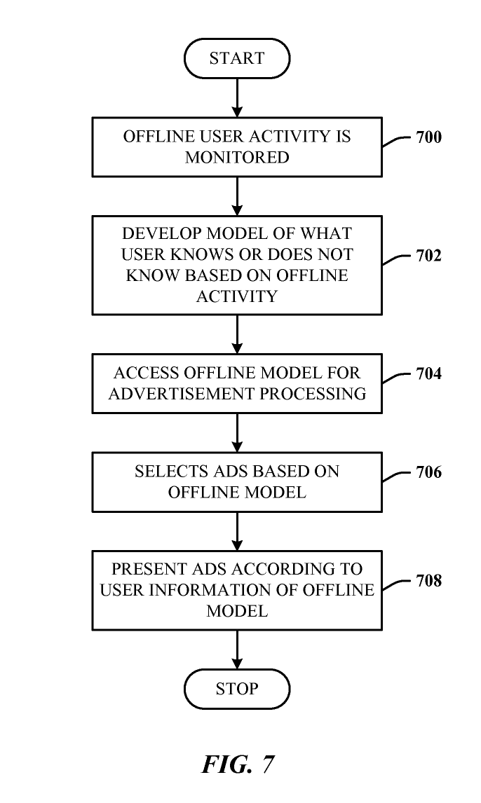

In view of these sources of information (both offline and online), models can be developed and utilized to further refine targeted advertising to the user. FIG. 7 illustrates a methodology of modeling what a user knows or does not know based on offline user activity and using this model for online targeted advertising. At 700, offline user activity is monitored. At 702, a model of what the user knows (or does not know) is developed based on the offline activity. At 704, the offline knowledge model of the user is accessed by the advertising component for processing. At 706, the offline model is utilized for selecting ads. The ads are then presented to the user, as indicated at 708.

The model can also include information related to the user's preferences to brand, brand loyalty, pricing, and regularities in product purchases, for example. Properties related to at least these can be processed and utilized for selecting and presenting ads to the user.

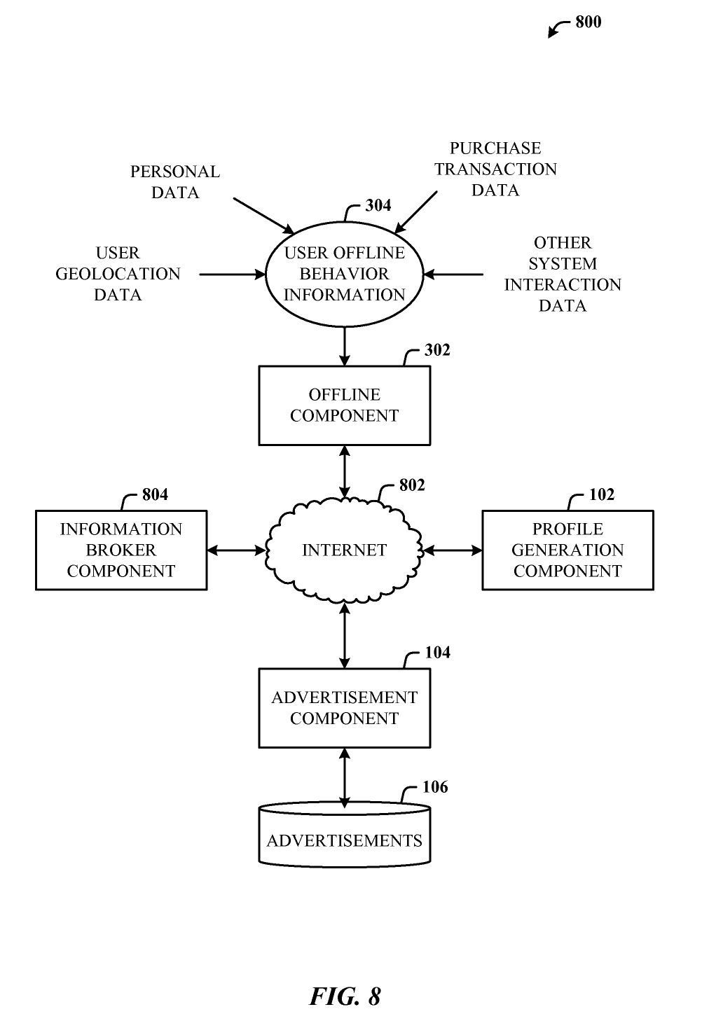

FIG. 8 illustrates a system 800 that facilitates brokering of offline user activity information in accordance with an innovative aspect. The system 800 includes the profile generation component 102 that generates at least one user profile based on the source of offline behavior information 304 as received and processed by the offline component 302 and, the advertisement component 104 and advertisement datasource 106 for storing and selecting one or more advertisements and for targeted advertising to the user during at least online activity. Here, the offline component 302, profile component 102, and advertising component 104 are shown disposed as separate nodes on the Internet 802. Additionally, an information broker component 804 is provided as a network node for brokering user information to network entities. For example, the broker component 804 can receive offline information from the offline component 302, and broker it to other network entities.

In one implementation, a merchant who obtains or has offline information about its customers can offer that information out to bid to other entities via the broker component 804. Similarly, an entity seeking such offline information can bid and/or receive the offline information via the broker component 804. For example, to complete or improve an offline profile, a merchant may need more information about a user's offline travel exploits. Accordingly, the merchant can access the broker component 804 as a means of obtaining this information (e.g., by purchase or exchange).

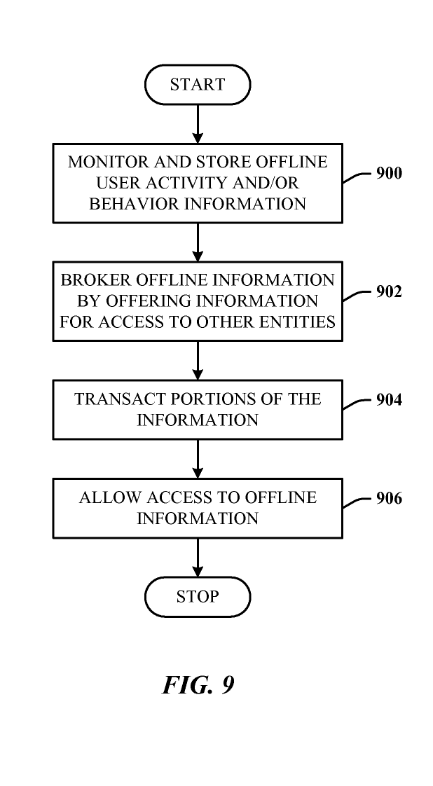

FIG. 9 illustrates a flow diagram of a methodology of brokering user offline information. At 900, user offline activity and/or behavior information is monitored and stored. At 902, access to the offline information or selected portions thereof is offered. At 904, the information or portions thereof is transacted. At 906, the transacted information is exposed to or communicated to the transacting party.

The success or failure (or relative value) of profiles can be measured and quantified in a value such that each profile can be assessed according to this value. Thus, a profile may have a high value in one area of content, but a lower value when utilized in another content area. Profiles can be categorized and clustered according to these values for determining application for particular types of advertising. Thus, the value provides some measure of guarantee that a given profile will align with the intentions, goals, etc., of the user for purposes of targeted advertising.

The disclosed architecture can also accommodate CPM-based advertising. CPM (or cost per thousand impressions) is based on the number of impressions or downloads of the content. An impression is a single instance of an advertisement that appears on a webpage. Under CPM, if the vendor pays $5 for 1,000 impressions, and the ad receives a click-through rate of two percent, the vendor pays $5 for the same 20 clicks.

Commission-based advertising can also be implemented using the disclosed architecture. For example, the amount of commission can be based on the accuracy or quality of the offline information for returning a positive interaction (e.g., click-through) from the online user. Similarly, the commission is reduced based on failure of the ad to generate the desired result.

Under conditions of success or failure to achieve the desired results, optimizations can be computed and put into practice. This can be differentiated for the many different brands as well as format and content.

On a macro scale, many facets of the online world can also be instrumented to develop trends and other useful data form network levels down to the individual node level to better determine online user reaction to such marketing. For example, based on major offline national events (e.g., Super Bowl or television programs), the online user reaction to such events as they unfold can be monitored for trends in user behavior. This information can be utilized quickly to target advertising at the users during these major events.

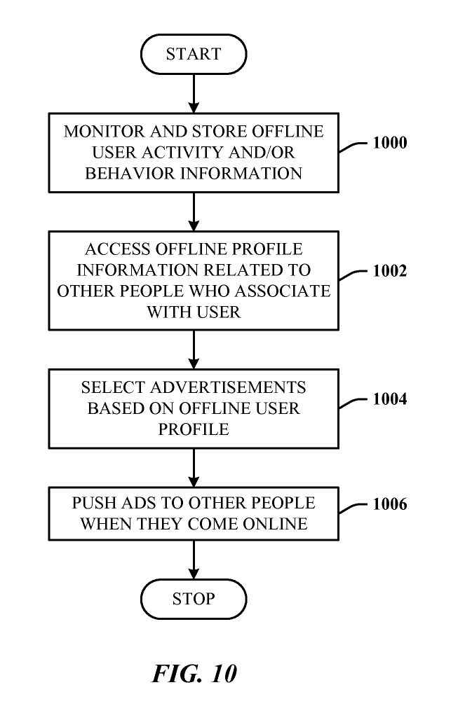

FIG. 10 illustrates a methodology of advertising as represented by a viral ecosystem model for advertising. In one implementation of the model, users who tend to interact with other users having similar interests can be targeted with similar advertising. At 1000, offline user activity and/or behavior information is monitored and stored. At 1002, profile information related to other users with whom the user interacts is accessed. For example, information from the user's e-mail contacts can be utilized as well as how often the user interacts via e-mail with these users. At 1004, advertisements are selected based on the user profile. At 1006, the selected advertisements are pushed to other people when they come online and who are inferred to have similar interests.

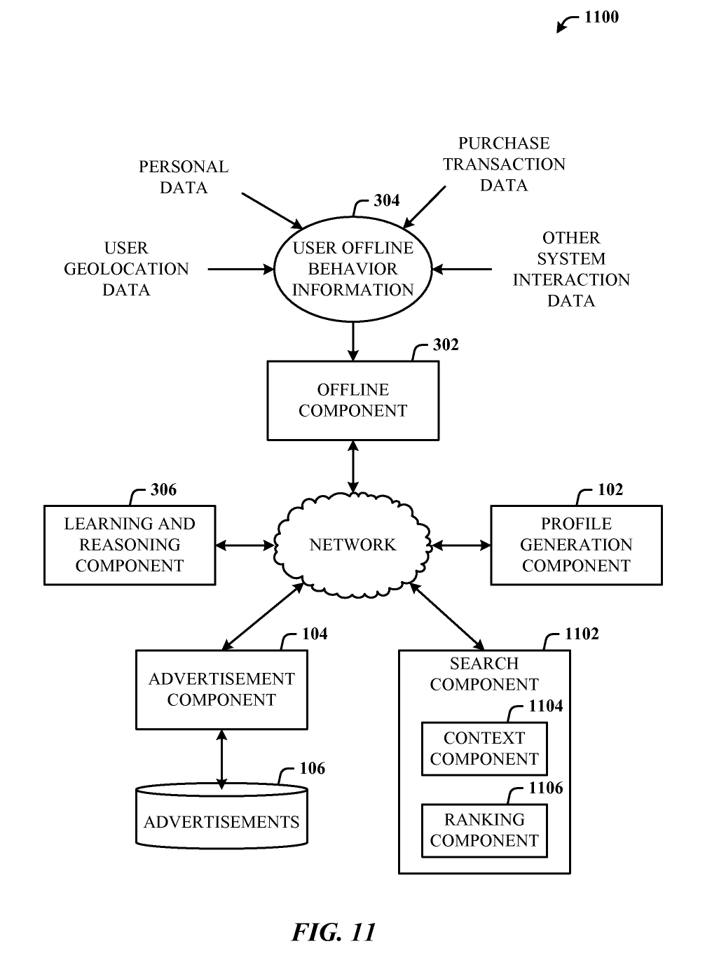

FIG. 11 illustrates a block diagram of a system 1100 that employs offline user information in support of searching and search processes. The system 1100 includes the profile generation component 102, the advertisement component 104, and advertisements storage system 106, as described in supra. Additionally, the system 1100 includes the offline component 302 that interfaces to external systems to receive the offline user behavior information 304. Inputs to the offline behavior information 304 include at least user geolocation data (which can be obtained automatically via geographic location technologies, e.g. global positioning system), person data (which includes personal financial data, person medical data, personal family data, and other data considered private), purchase transaction data (related to purchase made via retail brick-and-mortar establishments, as well as online purchases), and system interaction data (e.g., television content viewing, cell phones, computers, . . . ) associated with other systems that can be operated offline. The behavior information 304 is received by the offline component 302 and accessed for generating a user profile of offline information by the generation component 102.

The system 1100 further includes a search component 1102 that facilitates creating and/or executing online searches based on offline user activity. Additionally, results of the search can also be processed based on the offline profile information.

The offline monitoring of user activity and interaction data can also be utilized to enhance context-based searching when the user goes online to get information related to an offline event or activity. For example, if the offline behavior indicates the user was watching a television sports event between college teams, and thereafter the user was viewing an online sports website for highlights of the game, if the user goes online during or just after such television sporting event, an inference can be made that the user is interested in viewing more online information about the game, as well as being receptive to online advertisements selling college team memorabilia. Accordingly, the search component 1102 can include a context component 1104 that tracks user context, and based on context information, facilitates searching as performed or assisted by the search component 1102.

In yet another implementation, ranking of search results and other content to be displayed can be facilitated as a function of the offline behavior. Accordingly, the search component 1102 can also include a ranking component 1106 that provides ranking analysis and processing. This includes ranking not only data obtained from the user profile and using the ranked profile information for formulating the search query, but also for ranking the search results. In another implementation, only the search results are ranked.

The system 1100 can employ the learning and reasoning component 306 for automating one or more search-related features. For example, the component 306 can be utilized in connection with search formulation and execution based on the offline user activity. Additionally, or alternatively, the learning and reasoning component 306 can be utilized for context sensing and analysis, and ranking of information. For example, inferences can be made about offline user intentions and goals based on learning and reasoning of user offline activity or behavior, the results of which can be further used for ranking online search results.

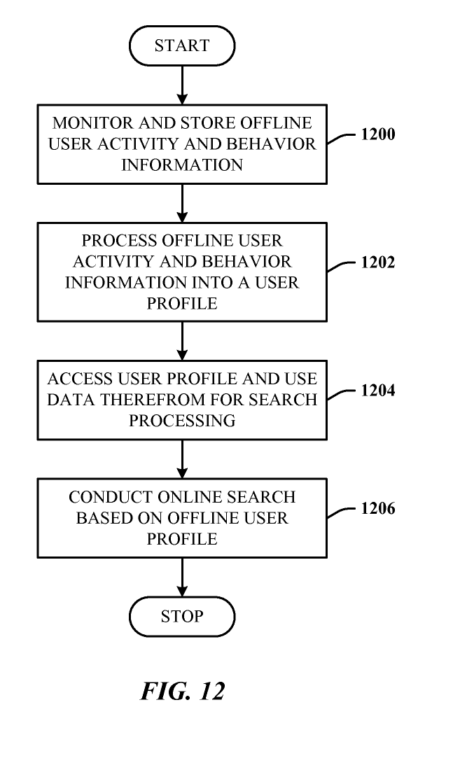

FIG. 12 illustrates a methodology of using offline user activity data in support of online searching in accordance with an innovative aspect. At 1200, offline user activity and behavior information is monitored and stored. At 1202, the offline information is processed into a user profile. At 1204, the search component accesses the user profile and processes information therefrom as part of search query formulation and execution. At 1206, an online search is conducted based on offline user profile information and results returned.

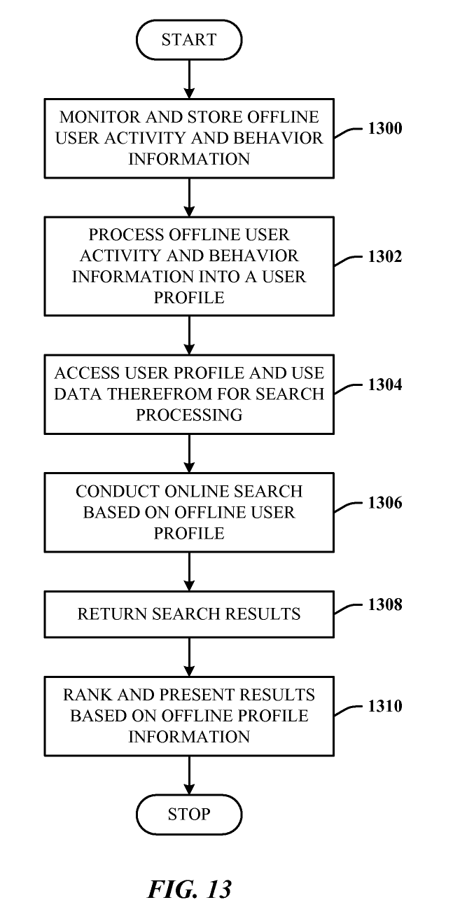

FIG. 13 illustrates a methodology of using offline user activity data in support of online search ranking in accordance with an aspect. At 1300, offline user activity and behavior information is monitored and stored. At 1302, the offline information is processed into a user profile. At 1304, the search component accesses the user profile and processes information therefrom as part of a search query formulation and execution. At 1306, an online search is conducted based on offline user profile information. At 1308, the search results are returned. At 1310, the results are ranked and presented to the user based on the user's offline profile information.

Offline activity data or behavior information ranking can also be used to facilitate creation of personalized online yellow pages. For example, such offline activity can be analyzed for priority interest, intention and goals. Based on this information, an online personal yellow page can be created using this priority information, or for searching for others who have similar interests, goals and/or intentions. This also means that in one implementation, as offline behavior changes, the yellow page information can also change. Alternatively, the information can remain fixed for a period of time.

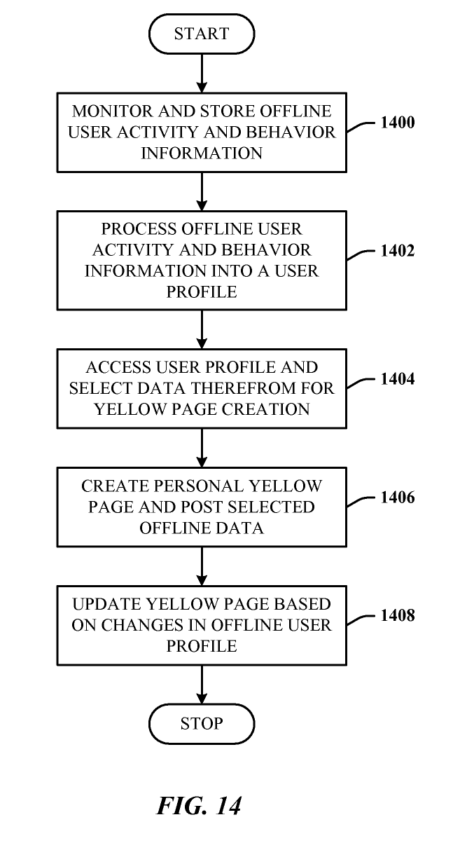

FIG. 14 illustrates a methodology of using offline user activity data in support of creating personal online yellow pages in accordance with an aspect. At 1400, offline user activity and behavior information is monitored and stored. At 1402, the offline information is processed into a user profile. At 1404, the user profile is accessed and data selected therefrom for yellow page creation. At 1406, the personal yellow page is created and the selected offline profile information posted thereon. At 1408, the personal yellow page is updated based on changes in the offline user profile information.

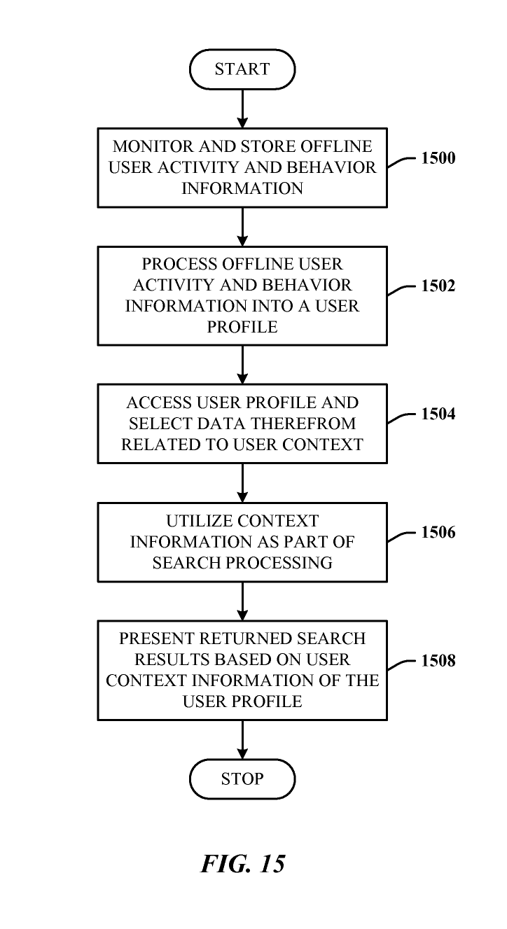

FIG. 15 illustrates a methodology of using offline user activity data for context-based searching in accordance with an aspect. At 1500, offline user activity and behavior information is monitored and stored, which include user context information. At 1502, the offline information is processed into a user profile. At 1504, the user profile is accessed and data selected therefrom related to user context. At 1506, the context information is utilized as part of the search process. At 1508, the search results are returned and presented based on at least the context information of the user profile.

It is to be understood that context information can include the physical location of the user as determined by, for example, a transaction being conducted at a brick-and-mortar retail establishment, the location of which can be ascertained. Context also includes software environment, for example, the program environment in which or from which a computer user is currently operating.

Online searching can be personalized based on client-side processing of the search query. For example, profile information can be stored locally and accessed for searching using personal information from the user profile. Moreover, the returned search results can include some of the personal information embedded in the advertisement content.

User interaction with client system hardware and/or software also provides a source of offline profile information. For example, from the fact that the user predominantly uses wireless devices (e.g., wireless keyboard and wireless mouse), it can be inferred that the user may desire to see search results and/or advertising related to new technologies for client system wireless devices (e.g., a wireless headset for audio or cellular use).

Additionally, personal metadata obtained as a by-product of file generation and/or storage from an application or any other metadata-generation entity can be employed in searching and targeted advertising. Keywords selected from the metadata can be inserted into search queries, and thereafter utilized for ranking the search results. Alternatively, personal metadata information can be employed to only rank the search results. In yet another implementation, the personal metadata can be included as part of the user profile, and extracted to affect the type and kind of advertisements that will be selected and presented to the user when online. Metadata such as video data, image data, textual data, markup data, toolbox and pallet information, and first class objects can be employed.

Customer relationship management (CRM) can also benefit from the search architecture of the innovation based on offline user behavior information. CRM includes the methodologies, strategies, software, and web-based capabilities for assisting an enterprise to organize and manage customer relationships, and includes a collection and distribution of data in all areas of the business. Parts of CRM architecture include an operational component for automation of the basic business processes (e.g., marketing, sales, service . . . ), an analytical component for supporting analysis of customer behavior, and a collaborative component for ensuring contact with customers through available communications media.

Bookmarking information, indexed reminders, available over grades can also be utilized in searches for ranking search results.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

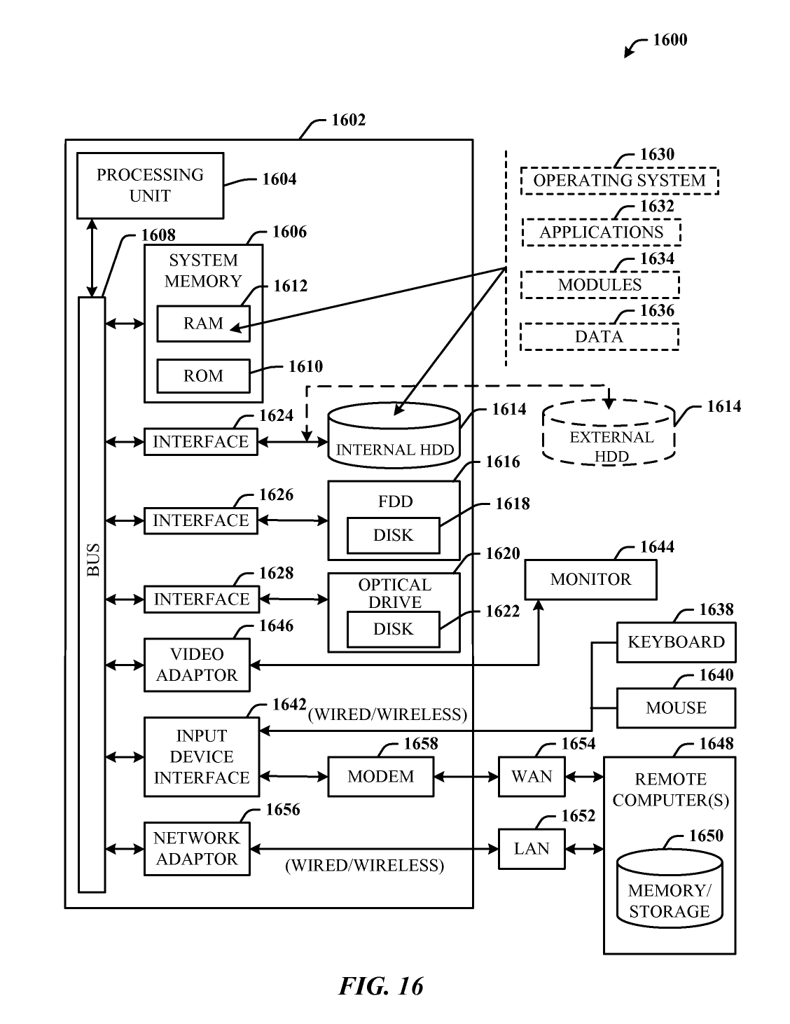

Referring now to FIG. 16, there is illustrated a block diagram of a computer operable to execute the disclosed offline profile advertising and searching architecture. In order to provide additional context for various aspects thereof, FIG. 16 and the following discussion are intended to provide a brief, general description of a suitable computing environment 1600 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 16, the exemplary environment 1600 for implementing various aspects includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures may also be employed as the processing unit 1604.

The system bus 1608 can be any of several types of bus structure that may further interconnect to a memory bus (with or without a memory controller), a peripheral bus, and a local bus using any of a variety of commercially available bus architectures. The system memory 1606 includes read-only memory (ROM) 1610 and random access memory (RAM) 1612. A basic input/output system (BIOS) is stored in a non-volatile memory 1610 such as ROM, EPROM, EEPROM, which BIOS contains the basic routines that help to transfer information between elements within the computer 1602, such as during start-up. The RAM 1612 can also include a high-speed RAM such as static RAM for caching data.

The computer 1602 further includes an internal hard disk drive (HDD) 1614 (e.g., EIDE, SATA), which internal hard disk drive 1614 may also be configured for external use in a suitable chassis (not shown), a magnetic floppy disk drive (FDD) 1616, (e.g., to read from or write to a removable diskette 1618) and an optical disk drive 1620, (e.g., reading a CD-ROM disk 1622 or, to read from or write to other high capacity optical media such as the DVD). The hard disk drive 1614, magnetic disk drive 1616 and optical disk drive 1620 can be connected to the system bus 1608 by a hard disk drive interface 1624, a magnetic disk drive interface 1626 and an optical drive interface 1628, respectively. The interface 1624 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. It is to be appreciated that the innovation can be implemented with various commercially available operating systems or combinations of operating systems.

A user can enter commands and information into the computer 1602 through one or more wired/wireless input devices, for example, a keyboard 1638 and a pointing device, such as a mouse 1640. Other input devices (not shown) may include a microphone, an IR remote control, a joystick, a game pad, a stylus pen, touch screen, or the like. These and other input devices are often connected to the processing unit 1604 through an input device interface 1642 that is coupled to the system bus 1608, but can be connected by other interfaces, such as a parallel port, an IEEE 1394 serial port, a game port, a USB port, an IR interface, etc.

A monitor 1644 or other type of display device is also connected to the system bus 1608 via an interface, such as a video adapter 1646. In addition to the monitor 1644, a computer typically includes other peripheral output devices (not shown), such as speakers, printers, etc.

The computer 1602 may operate in a networked environment using logical connections via wired and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1650 is illustrated. The logical connections depicted include wired/wireless connectivity to a local area network (LAN) 1652 and/or larger networks, for example, a wide area network (WAN) 1654. Such LAN and WAN networking environments are commonplace in offices and companies, and facilitate enterprise-wide computer networks, such as intranets, all of which may connect to a global communications network, for example, the Internet.

When used in a LAN networking environment, the computer 1602 is connected to the local network 1652 through a wired and/or wireless communication network interface or adapter 1656. The adaptor 1656 may facilitate wired or wireless communication to the LAN 1652, which may also include a wireless access point disposed thereon for communicating with the wireless adaptor 1656.

When used in a WAN networking environment, the computer 1602 can include a modem 1658, or is connected to a communications server on the WAN 1654, or has other means for establishing communications over the WAN 1654, such as by way of the Internet. The modem 1658, which can be internal or external and a wired or wireless device, is connected to the system bus 1608 via the serial port interface 1642. In a networked environment, program modules depicted relative to the computer 1602, or portions thereof, can be stored in the remote memory/storage device 1650. It will be appreciated that the network connections shown are exemplary and other means of establishing a communications link between the computers can be used.

The computer 1602 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, for example, computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11 g applies to wireless LANs and provides 20+Mbps in the 2.4 GHz band. Products can contain more than one band (e.g., dual band), so the networks can provide real-world performance similar to the basic 10BaseT wired Ethernet networks used in many offices.

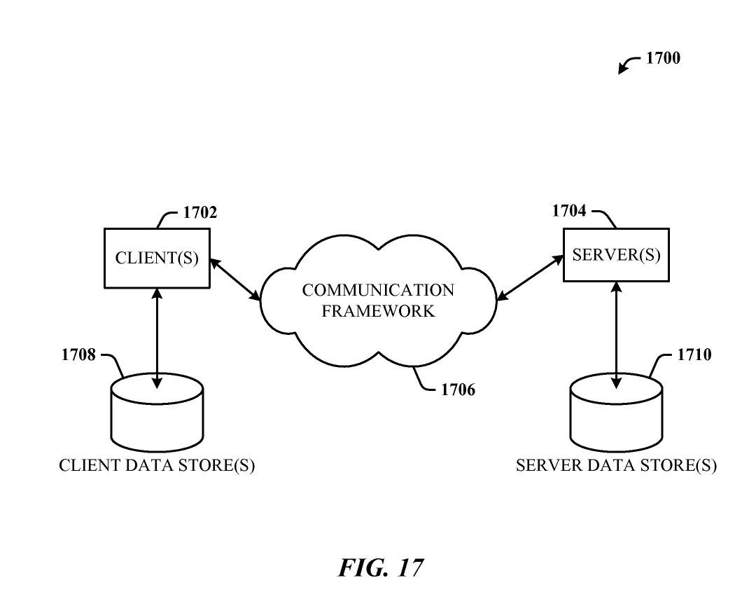

Referring now to FIG. 17, there is illustrated a schematic block diagram of an exemplary computing environment 1700 for offline profile advertising and searching in accordance with another aspect. The system 1700 includes one or more client(s) 1702. The client(s) 1702 can be hardware and/or software (e.g., threads, processes, computing devices). The client(s) 1702 can house cookie(s) and/or associated contextual information by employing the subject innovation, for example.

The system 1700 also includes one or more server(s) 1704. The server(s) 1704 can also be hardware and/or software (e.g., threads, processes, computing devices). The servers 1704 can house threads to perform transformations by employing the invention, for example. One possible communication between a client 1702 and a server 1704 can be in the form of a data packet adapted to be transmitted between two or more computer processes. The data packet may include a cookie and/or associated contextual information, for example. The system 1700 includes a communication framework 1706 (e.g., a global communication network such as the Internet) that can be employed to facilitate communications between the client(s) 1702 and the server(s) 1704.

Communications can be facilitated via a wired (including optical fiber) and/or wireless technology. The client(s) 1702 are operatively connected to one or more client data store(s) 1708 that can be employed to store information local to the client(s) 1702 (e.g., cookie(s) and/or associated contextual information). Similarly, the server(s) 1704 are operatively connected to one or more server data store(s) 1710 that can be employed to store information local to the servers 1704.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates online advertising, comprising:
a profile component that aggregates offline behavior information of a user and generates a related user profile; and
an advertising component that employs the user profile in connection with delivery of an advertisement to the user when the user is online.

2. The system of claim 1, further comprising an offline component that retrieves offline data associated with other system interaction data, which is cellular telephone interaction data.

3. The system of claim 1, further comprising an offline component that retrieves offline data related to user transactions of the user for purchasing an article of commerce.

4. The system of claim 1, further comprising an offline component that retrieves offline data related to physical location of the user.

5. The system of claim 1, wherein the advertising component facilitates delivery of the online advertisements in realtime.

6. The system of claim 1, further comprising a selection component that selects the advertisement for delivery to the user when online.

7. The system of claim 1, further comprising a selection component that selects advertisement content based a particular subset of profile data of the offline behavior information.

8. The system of claim 1, further comprising a search component that utilizes the offline behavior information for performing a search when the user is online.

9. The system of claim 1, further comprising a machine learning and reasoning component that employs a probabilistic and/or statistical-based analysis to prognose or infer an action that a user desires to be automatically performed.

10. The system of claim 1, further comprising a machine learning and reasoning component that makes an inference about selection of an advertisement to present based on temporal information related to online and offline activity.

11. A computer-implemented method of advertising online, comprising:
monitoring offline activity of a user;
storing offline data related to the offline activity in a user profile;
selecting an advertisement based on the user profile; and
presenting the advertisement to the user when the user is online.

12. The method of claim 11, wherein presenting is performed in realtime.

13. The method of claim 11, further comprising correlating the offline activity with online activity of the user.

14. The method of claim 13, further comprising dynamically adjusting advertisement processing by presenting an advertisement with a high probability of click-through rate.

15. The method of claim 11, further comprising modeling what the user knows based on the offline activity.

16. The method of claim 11, further comprising generating multiple user profiles each tailored to a different category of interest of the user.

17. The method of claim 11, further comprising downloading a bundle of related advertisements to a client system of the user based on the user profile and selectively presenting one of the advertisements based on online activity.

18. The method of claim 11, further comprising monitoring feedback from the user based on demeanor information and changing the advertisement based on the demeanor information.

19. The method of claim 11, further comprising brokering information of the user profile to another entity.

20. A computer-executable system, comprising:
computer-implemented means for sensing offline activity data of a user;
computer-implemented means for receiving and storing the offline activity data in a user profile;
computer-implemented means for selecting one or more advertisements based on portions of information accessed from the user profile; and
computer-implemented means for presenting the one or more advertisements to the user when the user is online.
